(19) United States
(12) Patent Application Publication
(10) Pub. No.: US 2005/0047668 A1
(43) Pub. Date: Mar. 3, 2005

(54) Method and arrangement for signal processing particular image signal processing

(76) Inventor: Marco Winzker, Hannover (DE)

Correspondence Address: WILLIAM COLLARD;COLLARD & ROE, P.C., 1077 NORTHERN BOULEVARD, ROSLYN, NY, 11576, US

(21) Appl. No.: 10/490,352

(22) PCT Filed: Sep. 20, 2002
(86) PCT No.: PCT/EP02/10602

(30) Foreign Application Priority Data
Sep. 20, 2001 (DE) 10146416.9

(51) Int. Cl. G06K 9/48

(52) U.S. Cl. 382/241

(57) ABSTRACT

The invention relates to a method and an arrangement for signal processing, in particular image signal processing, whereby, in particular for scanning values of input and/or output values, polynomials are calculated and, starting from input co-ordinates (x, y), co-ordinate transformations are carried out to give transformed co-ordinates (F OUT). According to the invention, the calculation of a polynomial is achieved by successive multiplication of a first partial polynomial and the second partial polynomial is not used on calculating the polynomial. The arrangement comprises processing units (PE) which can be configured, and with which the first partial polynomials are calculated.

### TECHNICAL BACKGROUND

This invention relates to a method and an arrangement for signal processing, in particular for image signal processing according to the preamble of claims 1 and/or 5.

Transformed coordinates are needed when discrete signal processing is to generate and/or equalize a distortion of the spatial and/or time dimension of a signal. Such signal processing works sequentially with variable coordinates. Transformed coordinates must be calculated for these input coordinates. Transformed coordinates are used to read data for signal processing and/or to store the results of processing.

Transformed coordinates must be computed separately for each scanning value of an input signal or output signal. In the case of image data in particular, this requires an enormous computation capacity. This high computation capacity can be made available efficiently by an arithmetic processing unit.

A very flexible definition of a coordinate transformation is possible by using a polynomial-based formula. One example is a polynomial of the fourth order with an input coordinate “x” which is given as follows:
f(x)=c₀+C₁·x+c₂·x²+c₃·x³+c₄·x⁴ (equation 1)

The coefficients “c” define the function of the polynomial.

Several polynomials must be calculated with different coefficients for transformation of multiple coordinates “(x, y, z, . . . )” to transformed coordinates “(xₜ, yₜ, zₜ, . . . )”.

State of the Art

It is very complex to implement the calculation of equation 1 directly. In particular the high number of multiplications results in a very complex circuitry implementation.

A more efficient calculation is possible if the multiplications for calculation of the exponents of the input coordinates “x” are combined with the multiplications of the coefficients “cₙ.” This represents a successive multiplication of partial polynomials according to the following equation:
f(x)=c₀+x·(c₁+x·(c₂+x·(c₃+x·c₄))) (equation 2)

Practical problems, especially image processing, however, require a high level of complexity, even in the case of a circuit implementation according to equation 2.

Object

The object of this invention is to provide a method and an arrangement of the type defined in the preamble which will reduce the required computation complexity.

Achievement

This object is achieved with the features of claims 1 and 5. Coordinate transformation is performed by successive multiplication of partial polynomials; some coefficients are equated with zero by using symmetries.

This invention is associated with many advantages. The number of required multiplication steps of kept low and the complexity of the inventive circuit configuration is reduced.

At the same time, the coordinate transformation is designed to be practically universally configurable so that a plurality of applications is supported.

This invention will now be described on the basis of the figures, which show:

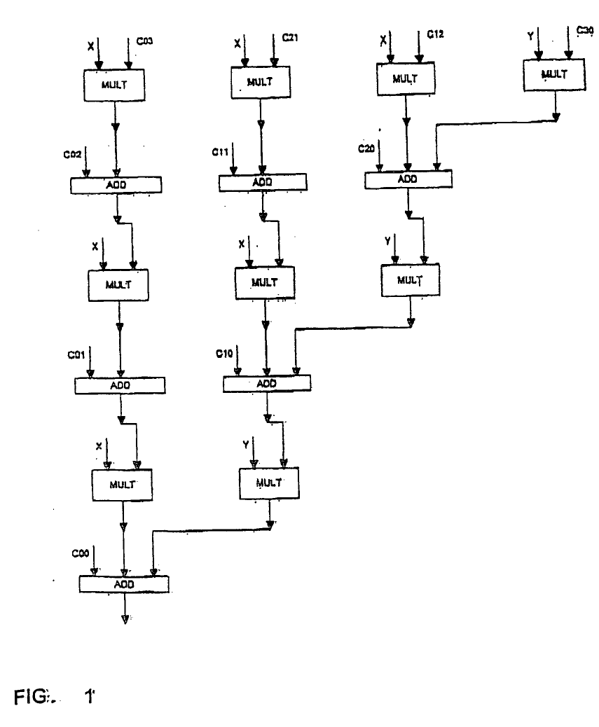

FIG. 1 a circuit configuration for computation of a polynomial of the third order according to the state of the art;

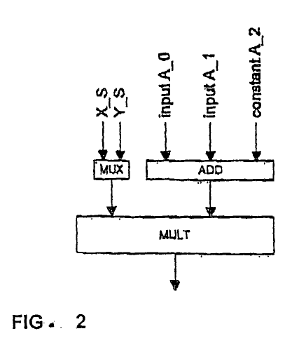

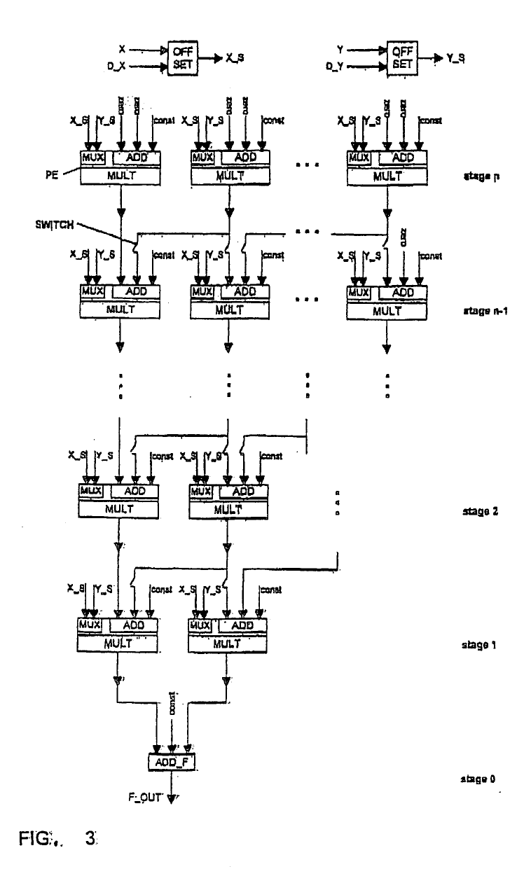

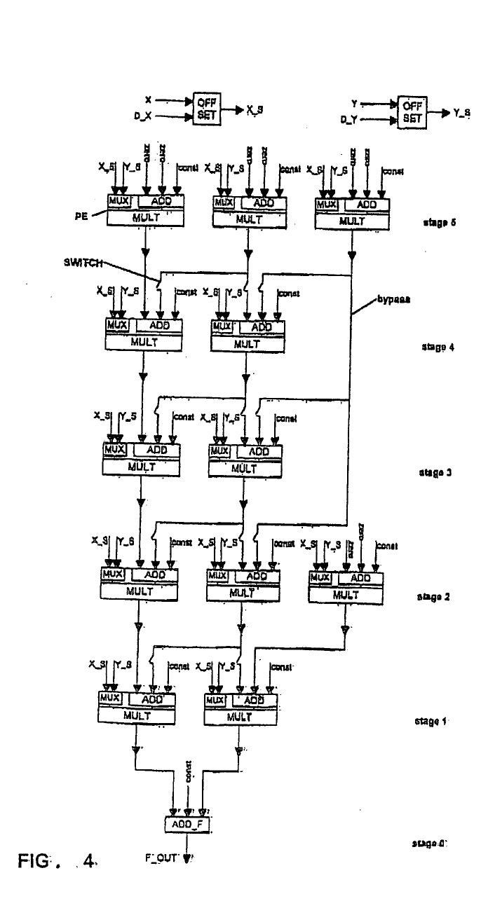

FIG. 2 a submodule of an inventive circuit configuration according to FIG. 3 or FIG. 4;

FIG. 3 a first exemplary embodiment of an inventive circuit configuration and

FIG. 4 a second exemplary embodiment of an inventive circuit configuration.

### EXEMPLARY EMBODIMENT

The following equation holds for the calculation of a coordinate transformation with two input coordinates “x” and “y” and a third-order polynomial:

$$f ( x , y ) = {c}_{00} + {c}_{01} \cdot x + {c}_{10} \cdot y + {c}_{02} \cdot {x}^{2} + {c}_{11} \cdot x \cdot y + {c}_{20} \cdot {y}^{2} + {c}_{03} \cdot {x}^{3} + {c}_{12} \cdot {x}^{2} \cdot y + {c}_{21} \cdot x \cdot {y}^{2} + {c}_{30} \cdot {y}^{3} \qquad ( equation 3 )$$

This can be implemented more efficiently with the following computation:

$$f ( x , y ) = {c}_{00} + x \cdot ( {c}_{01} + x \cdot ( {c}_{02} + x \cdot {c}_{03} ) ) + y \cdot ( {c}_{10} + x \cdot ( {c}_{11} + x \cdot {c}_{21} ) + y \cdot ( {c}_{20} + x \cdot {c}_{12} + y \cdot {c}_{30} ) ) \qquad ( equation 4 )$$

A circuit architecture which implements this computation directly is shown in FIG. 1. The modules labeled as MULT perform a multiplication and the modules labeled as ADD perform addition. The modules MULT for multiplication are especially complex. For calculation of equation 4, nine multiplication modules are needed.

Image processing applications often have an inherent symmetry. This symmetry results, for example, from projection or image acquisition by using a lens system. There is an optical axis which is at the center of the lens and is thus at the center of the image. Interference due to the lens is then symmetrical with an axis. An axis of symmetry may also result from the arrangement of a projection system in relation to the surface onto which the image is to be projected. This symmetry, i.e., redundancy is utilized and the number of multiplication steps is reduced. To do so, it may be necessary to shift the input coordinates so that the axis of symmetry coincides with the zero point of the coordinates.

The symmetries may also be determined by computation, in which case this will also determine which coefficients c are set at zero so that the corresponding (“second”) partial polynomials are not used in calculation of a polynomial.

As an example, let us use equation 5, for calculation of which three multiplication steps are necessary.
f(x, y)=20−2·x−10·y+2·x·y=20+x·(−2+2 y)−10y (equation 5)

Equation 5 contains a symmetry with respect to x=5 and y=1. By subtracting these values, this yields the following equivalent equation:
f(x,y)=10+2·(x−5)·(y−1) (equation 6)

For calculation of equation 6 only two multiplication steps are needed (instead of three, as in equation 5) so that the circuit complexity can be eliminated. The shift in coordinates by subtraction can be performed jointly for each use of a coordinate. This means that the shifted coordinates “xₛ” and “yₛ” are calculated first. The polynomial for the coordinate transformation is then based on these shifted coordinates. For the example from equation 6, equation 7 thus yields the following:
f(xₛ, yₛ)=10+2·xₛ·yₛ
with
xₛ=x−5; yₛ=y−1 (equation 7)

An efficient circuit architecture for calculation of polynomial-based multidimensional coordinate transformations is based on a submodule called a PE as depicted in FIG. 2.

The submodule PE receives as input the coordinates shifted to the axes of symmetry, shown for two coordinates “xₛ” and “yₛ” in the figure. One coordinate is selected by a multiplexer (MUX) and made available as a multiplicand to a multiplication submodule (MULT). The multiplier is formed by an adder (ADD) from the sum of the other inputs. These inputs are a fixed constant (const) and output signals of preceding stages.

FIG. 3 shows the circuit architecture for calculation of coordinate transformations. The circuit architecture consists of subtractors (OFFSET) for calculation of the shifted coordinates X_S, Y_S as the difference between the input coordinates X, Y and a programmable constant D_X, D_Y. The shifted coordinates are sent to submodules PE which are arranged in a cascade (stage 0, stage 1, stage 2, stage n-1, stage n). The outputs of a submodule PE are connected to the inputs of a submodule or to the inputs of multiple submodules PE of a subsequent stage. If a submodule PE is connected to multiple subsequent submodules PE, these connecting lines may be configured via switches (SWITCH). The switches (SWITCH) relay output signals of a PE or replace them by the value zero.

The results of the last stage at submodules PE (stage 1) are combined with another constant (const) with a final adder (ADD_F) (stage 0) and form the transformed coordinate F_OUT.

The number of stages determined the degree of the polynomial that can be calculated with the overall circuit. The number of submodules PE per stage determined the number of coefficients not equal to zero that can be selected per degree of polynomial and thus the number of “first partial polynomials” that can be calculated. “Second partial polynomials” for which the coefficients are equated with zero are not calculated on the basis of symmetries.

FIG. 4 shows an architecture which calculates a polynomial of the fifth order according to equation 8.

$$\begin{matrix}\begin{matrix}\begin{matrix}\begin{matrix}\begin{matrix}\begin{matrix}\begin{matrix}\begin{matrix}f ( {x}_{s} , {y}_{s} ) = {c}_{00} + \\ {c}_{00} + {c}_{01} \cdot {x}_{s} + {c}_{10} \cdot {y}_{s} +\end{matrix} \\ {c}_{02} \cdot {x}_{s}^{2} + {c}_{11} \cdot {x}_{s} \cdot {y}_{s} + {c}_{20} \cdot {y}_{s}^{2} +\end{matrix} \\ {c}_{03} \cdot {x}_{s}^{3} + {c}_{12} \cdot {x}_{s}^{2} \cdot {y}_{s} + {c}_{21} \cdot {x}_{s} \cdot {y}_{s}^{2} +\end{matrix} \\ {c}_{30} \cdot {y}_{s}^{3} + {c}_{04} \cdot {x}_{s}^{4} + {c}_{13} \cdot {x}_{s}^{3} \cdot {y}_{s} + {c}_{22} \cdot {x}_{s}^{2} \cdot {y}_{s}^{2} +\end{matrix} \\ {c}_{31} \cdot {x}_{s} \cdot {y}_{s}^{3} + {c}_{40} \cdot {y}_{s}^{4} + {c}_{05} \cdot {x}_{s}^{5} + {c}_{14} \cdot {x}_{s}^{3} \cdot {y}_{s} +\end{matrix} \\ {c}_{32} \cdot {x}_{s}^{3} \cdot {y}_{s}^{2} + {c}_{23} \cdot {x}_{s}^{2} \cdot {y}_{s}^{3} + {c}_{41} \cdot {x}^{5} \cdot {y}_{s}^{4} + {c}_{50} \cdot {y}_{s}^{5}\end{matrix} \\ where \end{matrix} \\ {x}_{s} = x - {d}_{x} ; {y}_{s} = y - {d}_{y}\end{matrix} \qquad ( equation 8 )$$

The lowest (bottom) stage (stage 0) processes the results of the preceding stage and adds the constant c₀₀ from equation 8.

Stage 1 contains two submodules PE which calculate the terms of the first degree (xₛ, yₛ) according to c₀₁ and c₁₀.

Stage 2 contains three submodules PE which calculate the terms of the second degree (xₛ², xₛ·yₛ, yₛ²) according to c₀₂, c₁₁ c₂₀.

Stage 3 contains two submodules PE which calculate the terms of the third degree (xₛ³, xₛ² ·yₛ, xₛ·yₛ² yₛ³) according to c₀₃, c₁₂, c₂₁, c₃₀. Since there are only two submodules PE, only two of the coefficients of this degree can be freely selected so two “first partial polynomials” are calculated. The other coefficients are set at zero (“second partial polynomials”).

Stage 4 contains two submodules PE which calculate the terms of the fourth degree (xₛ³, xₛ²·yₛ, xₛ·yₛ² yₛ³) according to c₀₄, c₁₃, c₂₂, c₃₁, c₄₀. As in the preceding stage (stage 2) again only two submodules PE are present so only two of the coefficients are freely selected (two “first partial polynomials”), while the other coefficients are set at zero (“second partial polynomials”).

Stage 5 contains three submodules PE which calculate the terms of the fifth degree (xₛ⁵, xₛ⁴·yₛ, xₛ³·yₛ², xₛ²·yₛ³, xₛ·yₛ⁴, yₛ⁵) according to c₀₅, c₁₄, c₂₃, c₃₂, c₄₁, c₅₀. With the three submodules PE, three of the coefficients can be selected for values not equal to zero (three “first partial polynomials”). Since this stage is not preceded by any other stage, the inputs of the submodule PE that are not used are connected to the value zero. The adders of the submodules PE may then be omitted and the signal identifying the constant is sent directly to the multiplication submodule of the submodule.

A submodule PE from stage 5 can be connected by the connection labeled as “bypass” not only to the input of a submodule PE from the next following stage (stage 4) but can also be connected to submodule (PE) inputs of other downstream stages (stage 3 and stage 2) in FIG. 3). Instead of a fifth-order term, another term of the fourth or third order may be implemented.

The configuration, i.e., circuit configuration described above with reference to FIGS. 3 and 4, can be controlled in such a way that a polynomial is calculated by successive multiplications of first partial polynomials and second partial polynomials are not used in calculation of the polynomial.

The configuration, i.e., the circuit configuration described above, may be a part (“CT”) of the configuration disclosed for image processing with concomitant coordinate transformation in German Patent 100 52 263 A1 (applicant: Liesegang Electronics GmbH, Hanover, Germany).

### List of Reference Notation

x, y Input coordinates
xₛ, yₛ Shifted coordinates
F_OUT Transformed coordinates
c0, . . . Coefficients
const Fixed constant
D_X, D_Y Programmable constants
MULT Multiplication module
ADD Addition module
MUX Multiplexer
OFFSET Subtractor
PE Submodule
Stage 0, . . . Submodule stage 0, . . .
SWITCH Switch

1. A method of signal processing in particular image signal processing whereby polynomials are calculated based on scanning values of input values and/or output values and coordinate transformations are performed on the basis of the input coordinates (x, y) and transformed coordinates (F_OUT) are formed,
wherein
a) a polynomial is calculated by successive multiplication of first partial polynomials and
b) second partial polynomials are not used in the calculation of the polynomial.

2. The method according to claim 1, wherein the second partial polynomials are determined on the basis of symmetries in the polynomial.

3. The method according to claim 1, wherein the input coordinates (x, y) are shifted by subtraction of constants (const, D_X; D_Y).

4. The method according to claim 3, wherein the same constant (const) is subtracted for each input coordinate (x, y) and the subtraction operations are combined.

5. A configuration for signal processing, in particular for image signal processing, according to a method of claim 1, wherein the arrangement is controllable in such a manner that a polynomial is computed by successive multiplication of a first partial polynomial in that way and second partial polynomials are not used in computation of the polynomial.

6. The arrangement according to claim 5, wherein the arrangement has configurable processing units (PE) with which the first partial polynomials are calculated.

7. The arrangement according to claim 6, wherein the configurable processing units (PE) are cascaded in at least two stages (stage 0, stage 1, stage 2, stage n=1, stage n) and are arranged in such a way that the output signals of one stage are processed further in one or more downstream stages.

8. The arrangement according to claim 6, wherein a configurable processing unit (PE) has a multiplexer unit (MUX), an addition unit (AD) and a multiplication unit (MULT), the multiplexer unit (MUX) selects a coordinate (X_S, Y_S) in such a way that the addition unit (ADD) adds at least one output signal of at least one upstream stage and at least one constant (const) and the multiplication unit (MULT) multipliers the output signals of the multiplexer unit (MUX) and the addition unit (ADD).

9. The arrangement according to claim 8, wherein a subtraction unit (OFFSET) is connected upstream from the configurable processing unit (PE) and forms the coordinate to be selected (X_S, Y_S) by the multiplexer unit (MUX) from an input coordinate (x, y) and a programmable constant (D_X, D_Y).

10. The arrangement according to claim 7, wherein output signals of at least one stage are not patched through by switches (SWITCH).

11. The arrangement according to claim 6, wherein it has fewer configurable processing units (PE) than are needed for calculation of a complete polynomial.
